(19) United States
(12) Patent Application Publication
(10) Pub. No.: US 2023/0208715 A1
(43) Pub. Date: Jun. 29, 2023

(54) OPTIMIZING NETWORK TRANSACTIONS FOR DATABASES HOSTED ON A PUBLIC CLOUD

(71) Applicant: salesforce.com, inc., San Francisco, CA (US)

(72) Inventors: Kalyan Chakravarthy THATIKONDA, San Francisco, CA (US); Ben SIGGERS, San Francisco, CA (US); Nikita RAJPUT, San Francisco, CA (US)

(73) Assignee: salesforce.com, inc., San Francisco, CA (US)

(21) Appl. No.: 17/565,260

(22) Filed: Dec. 29, 2021

(51) Int. Cl. H04L 41/0853; H04L 41/0866; H04L 41/0813; H04L 41/16; H04L 43/10

(52) U.S. Cl. CPC H04L 41/0853; H04L 41/0866; H04L 41/0813; H04L 41/16; H04L 43/10

(57) ABSTRACT

Configuration management e.g., configuration validation and remediation (when necessary) of entities in a collective of databases and/or other machines or devices can be burdensome when vendor/cloud provider tools are used to manage the entities due to lack of control over the management. Rather than rely on vendor/cloud provider tools, instead configuration management is offloaded to, e.g., a local API and/or local machine, where configuration deviation detection from an expected configuration is locally determined and remediation needs may be prioritized so higher-priority collective entities are remediated first and other entities deferred. Local processing reduces burdens associated with entity remediation, such as in a cloud-hosted environment having many burdens associated with accessing cloud data and/or databases.

### COPYRIGHT NOTICE

A portion of the disclosure of this patent document may contain material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

One or more implementations relate generally to configuration management and maintaining correctness of an entity configuration, and more specifically to prioritizing entities in a collective that includes databases to reduce burdens associated with maintaining configuration correctness of prioritized entities.

### BACKGROUND

The material discussed in this background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The advent of powerful servers, large-scale data storage and other information infrastructure has spurred the development of advanced data warehousing and data analytics applications. With effectively limitless storage and ever increasing communication/networking speeds, databases may be multiply-hosted and/or distributed across multiple local and/or remote environments, such as on a local area network (LAN), wide area network (WAN) and/or implemented wholly or in part as a cloud hosted database. Databases, and database access, have various associated burdens which may be measured in a variety of ways. Burdens include, for example, hardware resources required to perform the access, network bandwidth needed to transfer data, energy cost for running the various machines, data transfer fees for performing data access (read) and/or data store (write) operations, timing constraints, e.g., operate in a database's local green-window timing (a timeframe in which operations may be cheaper or otherwise less a burden and hence performance is skewed toward the green-window, as well as processing loads (e.g., executing a frequent cron job (or equivalent) to trigger a configuration validation, etc.

With large scale deployment, one collective may have 10,000 or more databases. If some or all of these databases are cloud based, maintaining the databases becomes an equally large scale problem. For example, a common problem is to confirm databases have an expected configuration. As will be appreciated, there are many tools and/or people manually performing operations on one or more databases, including security and configuration patching and updating. Over time, for various reasons, databases may deviate from an expected configuration. An ordinarily simple operation, such as to confirm a database has an expected configuration, and address it when misconfigured, may become very burdensome if there are a large number of databases to investigate, validate and remediate.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2 illustrates, according to one implementation, a high-level system diagram of a database environment in which various aspects of the disclosed technology may be used.

FIG. 3 illustrates a system diagram according to an exemplary implementation illustrating a corporate data center with a collective hosted by a vendor/cloud provider.

FIG. 4 illustrates a flowchart according to an exemplary implementation based at least in part on the context of the FIG. 3 system diagram.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for managing one or more entity. The term “entity” is used hereinbelow to generally refer to a database, as well as refer to a machine, which may be hosting one or more database. When discussing configuration deviation and remediation, while discussion may focus on databases, the principles are intended to be inclusive of database configuration and/or of its associated environment, such as the configuration of a database's host machine, other devices associated with a database, or other configurable aspects of the environment associated with a database. It will be appreciated a database may be part of a collective of databases, such as a large group containing thousands of databases and/or servers or other machines/devices, each having one or more associated configuration. Managing a collective (also referred to as a fleet) may be difficult, especially if database vendors provide tools that must be used in a particular way.

For example, Oracle® provides databases configured with a strict set of custom system standards and parameters, which are essential for the database operations to be successful. However, each set of standards are based on the particular operating system in use, hardware configuration, system resources, etc. Database vendors typically provide tools to manage a database collective. For example, Oracle provides tools based on an implementation of the open source “Puppet” software configuration, management, and deployment tool. Puppet provides a client/server model that may be used to ensure correctness of a system (which includes database correctness) using standard catalogs. It will be understood by one skilled in the art a catalog is a document that may be associated with a database and/or machine to describe a desired state of software and/or hardware, and may specify ordered dependency information relating to a desired state.

It will be appreciated the processes and procedures related to configuring, inspecting, validating (e.g. confirming correctness of a configuration), reconfiguring, applying system standards using configurations management tools to insure a desired database and/or machine state and/or configuration for controlled immutability results in incurring burdens for performing these processes and procedures, e.g., accessing databases and/or machines hosting one or more database. As discussed above, burdens may be measured in a variety of ways, including, for example, hardware resources required to perform the access, network bandwidth needed to transfer data, energy cost to run various machines, processes or procedures at various times of day, data transfer fees for performing data access (read) and/or data store (write) operations, timing constraints (e.g., try to operate in a database's local green-window to minimize costs), as well as processing loads such as from frequently executing cron jobs (or equivalent automated process) to trigger a configuration validation/reconfiguring, etc.

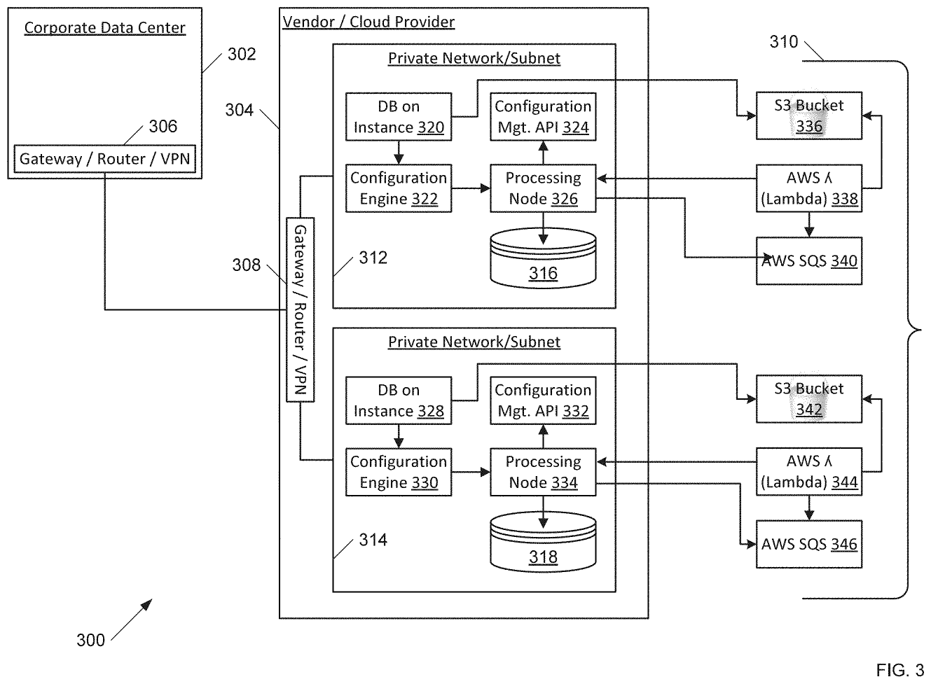

In some exemplary configurations, an Artificial Intelligence (AI) may be employed to locate databases and/or machines, evaluate whether a configuration has deviated from what is expected, determine whether the deviation is substantive requiring remediation, assign a status indicating at least an urgency of remediation, e.g., perform remediation immediately, sometime soon (e.g. after the immediate requirements), time permitting (e.g., low priority), cost permitting (e.g., to comply with green-window timing), etc., or perform other management operation as needed. Reference to AI includes AI “engines”, “machine intelligence”, “expert systems”, etc. that may assist with disclosed principles and operations, such as analyzing configuration catalogs, manifests, etc., identifying entities requiring remediation, determining what remediation entails, e.g., what update or other operation to perform, etc. AI may be based at least in part on one or more underlying reasoning system and/or decision processor, such as neural networks (feedforward, recurrent, deep learning, backpropagation, etc.), or other analytical system(s). In various implementations, AI may be incorporated into a local and/or remote computer system(s). For example, some AI implementations may require resources typically only available from a vendor/cloud provider (see, e.g., FIG. 3 item 304) with high compute machines, and hence some AI features may be available over a local network(s) and/or as a remote resource accessible over, for example, the Internet. It will be appreciated one or more AI resources may cooperatively operate to analyze problems and suggest answers.

The typical requirement of using database provider tools, such as the Puppet based tools, or other management tools, leads to various deployment and management challenges, such as an inability to perform a selective application of programs intended to manage the state of a database and/or associated environment. An example of such a program is a Puppet “manifest” (written in the Ruby programming language), but it will be appreciated the Puppet environment is simply one well-known example of management environments and that this or other environments, or a custom management system, may be used to monitor, investigate and remediate databases and/or host machines as needed. Rather than allowing selective manifest application based at least in part on the priority of the services configured on the systems (e.g., as may be reflected in a status indicating remediation urgency), instead vendor tools often require rolling out changes on a fleet of systems that are deviated from baseline manifests based on the vendor provided rollout model (e.g., based on vendor criteria).

Lack of control over remediation, in addition to risking urgent remediation being unnecessarily delayed, also increases network transactions (and other associated burdens as discussed above) as the scale of a collective increases. When some or all of a collective is in a private and/or public cloud, access to the cloud further increases the burden associated with managing a database collective, including substantially increasing compute costs when such access is metered. In addition to performance burdens, without control over remediation, configuration changes may be inconsistently applied across a collective, at least temporarily, due to various factors such as randomized timing offsets within a datacenter (to avoid excessive loads from multiple events scheduled to occur at the same time, e.g., midnight, requirements to perform operations during green-window timing, etc. Thus, while it will be appreciated remediation may eventually be consistent, given enough time, in a more immediate timeframe, there is no local control over a collective being in an inconsistent state with high-priority remediation potentially not being prioritized by a vendor/cloud provider over less-significant configuration inconsistencies.

Another issue with lack of remediation control is high-priority deviations, if left unaddressed, may cause compliance issues, service level agreement (SLA) violations, or trigger a cascade of other problems leading, in some cases, to service outages. In addition, a collective that is at least in part accessed through a cloud service, often operates under a “shared responsibility” model, where a vendor hosting a collective is responsible for maintaining security and other configuration compliance, and a customer is responsible for determining operation/tasks to be performed by the collective. Hence, as noted above, there may be little to no local control over the collective's management. By relegating maintaining the collective to the vendor, there may be a lack of visibility on the network layer for troubleshooting problems, such as an internal client-server communication issue across a collective of databases.

In various exemplary implementations, to minimize burdens and gain control over remediation, network transactions with at least cloud-hosted databases may be optimized. Rather than rely on vendor tools to manage entity configurations(s) in a collective, instead a customized configuration engine and processing nodes may be used to locally (e.g., off-cloud, off metered services, etc.) to at least identify databases that have deviated from an expected configuration and/or state. A remediation priority queue may be determined that identifies, for example, an ordering to applying remediation to systems, where the ordering avoids invoking conventional larger scale network transactions in a client-server communication model. Various illustrated implementations dynamically ensure local compliance, where local control provides, for example, for control without having to access the cloud for all entities in a collective.

It will be appreciated relatively inexpensive data storage costs, increasingly powerful microprocessor environments, and continued progress with Artificial Intelligence to process data, has facilitated collectives of increasing size and complexity. The task of inspecting entities in a collective, determining an extent of deviation, identifying a necessary remediation, and assigning a priority to the remediation is particularly challenging due to complex relationships between the entities in the collective. Therefore some exemplary implementations use powerful analytics hardware and/or software applying AI-augmented analysis to manage the collective and/or interact with vendor/cloud provider tools. It will be understood extensive compute resources may be required to process data associated with the collective to determine remediation needs, with a corresponding heavy burden to machines, databases, network infrastructure, etc. To increase efficiency and minimize burdens, as discussed below, analysis may be performed at least partially locally to minimize cloud access burdens as much as possible. In various exemplary implementations, an Application Programming Interface (API) may be used to locally manage a collective and remove some or all dependency on vendor cloud-based tools needed to manage the collective, and hence minimize management burdens.

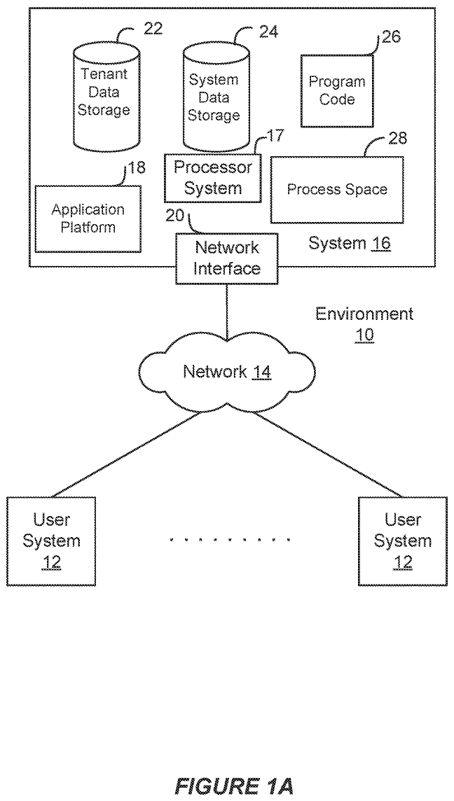

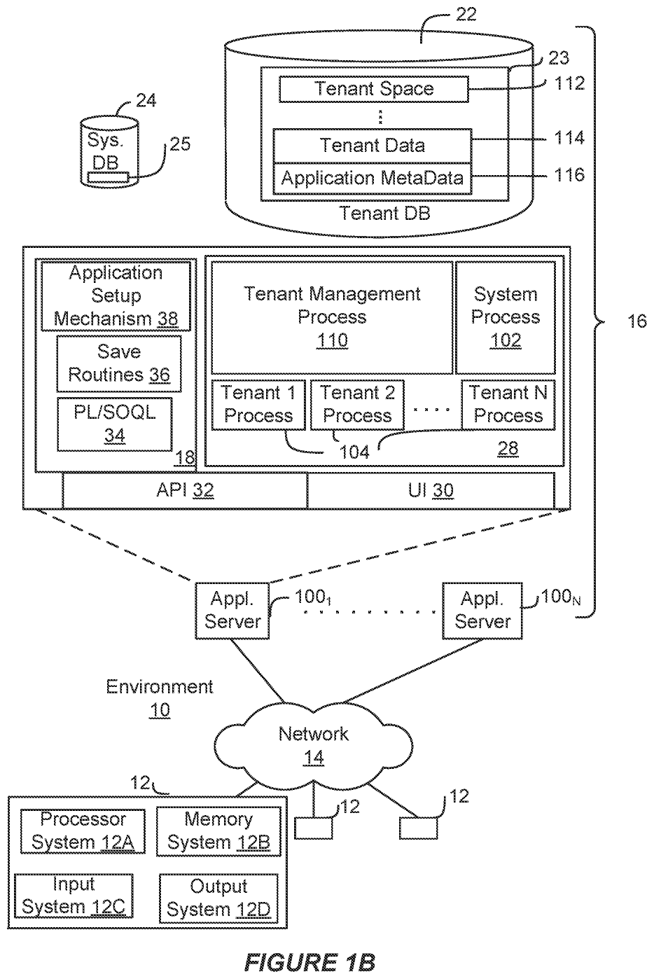

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. It will be appreciated “on demand” may refer to scheduling an action to occur according to a schedule, as well as to schedule an action to occur if “triggered” responsive to recognizing some event or condition of interest, e.g., to activate responsive to changes to specific data or to databases of interest, or if/when another dataflow/event of interest occurs. In the following description, even if not expressly called out, reference to an operation, dataflow, on demand activity, or application execution may be explicitly scheduled or implicitly scheduled, e.g., triggered. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein may be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Apple's Safari, Google's Chrome, Opera's browser, or Mozilla's Firefox browser, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel® processor or the like and/or multiple CPUs and/or multi-core processors. Similarly, the system 16 (and additional instances of an MTS, where more than one is present) and all of its components can be operator-configurable using application(s) including computer code to run using the processor system 17, which may be implemented to include a CPU, which may include an Intel® processor or the like and/or multiple CPUs and/or multi-core processors.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable or computer-accessible medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The processors, while shown disposed within the user system 12, may be a distributed collection of cooperatively executing processors or processing environments (not illustrated). The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine. The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above. In some implementations the API provides commands, functions and/or functionality to, for example, manage a database collective, determine when a machine and/or database in the collective has a configuration issue requiring remediation, as well as prioritizing remediation to ensure higher priority remediation occurs as soon as reasonably possible.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24, and requests may be made in accord with a schedule and/or automatically responsive, triggered in response to changes in datasets or monitored portions of databases that are of interest. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.” Changes made to a table or dataset may trigger one or more follow-on request to update other related data/objects/derived dataset/etc.

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

In a typical vendor-controlled configuration management environment, the vendor (e.g., Oracle) provides tools, e.g., management tools based on the open source “Puppet” software configuration, management, and deployment tool. As will be understood by one skilled in the art, puppet provides a client/server model that may be used to ensure correctness of the system using standard catalogs. A catalog is a document that may be associated with a database and/or machine to describe a desired state of software and/or hardware, and may specify ordered dependency information relating to a desired state. It is expected the reader is familiar with management systems such as puppet. Typically, Oracle or other vendor may retain control of deviation checking and remediation. If puppet is used on a database or database system hosts to manage their system configuration, a puppet agent is started on each host via, for example, a “cron” job. Cron is a well-known scheduling tool supported by many different operating systems, but any other scheduling tool or technology may be used. Typically, the cron job is set to run hourly within a ‘green window’, which corresponds to off-peak customer resource usage and varies geographically based on datacenter location. Actual job start times may be randomized to avoid simultaneous job starts.

In the vendor-controlled environment, puppet uses a “defined state configuration” process to ensure system configuration state consistency. When a configuration change is deployed via puppet, the change is deployed to the datacenter's (see, e.g., FIG. 3 item 302) puppet master, where it is picked up when the puppet agent is run on each database host (see, e.g., FIG. 3 items 320, 328 of items 312, 314). As the timing of the actual execution varies, both due to the randomized minute offset within the datacenter, and green-window timings differing between data centers, there may be a window of time where configuration changes are inconsistently applied; it will be appreciated changes will eventually be consistent, given enough time. In order to detect configuration deviation, puppet collects “facts” about a local node using a system called “facter”. This may include data such as memory, cpu type, disk layouts, installed RPMs, free disk space, and running processes. This may also include custom facts, which may be user defined and rolled out as part of puppet manifests.

Puppet begins collecting all defined facts and custom facts in the first phase of the puppet agent execution. When this collection process is complete, the hiera-data for the current node is loaded, which is a hierarchically organized set of data which is user defined and based on a node's place in the hierarchy (datacenter level, cluster level, host level, etc.). This is followed by loading the catalog. The puppet manifests contain the local resource definitions which define the expected state on the local node. Once these are all loaded, the catalog is checked, using the current system state (contents of files on filesystem, etc.) combined with the set of loaded facts. At this point, if discrepancies (deviation) between the defined state and current state are detected, puppet makes the required changes in order to bring the system from the current state to defined state.

Such tools lack a framework to customize the network queue of systems based on the context of custom requirements that are specific to environments and stateful services (e.g., Database, Search, Cache, etc.). In particular, the prescriptive nature of the management tools results in multiple different tools required to manage a collective, with each tool following its own architecture for the client-server communication model, and each tool having its own scheduler agent running on each entity (e.g., database host) in the collective to keep that tool's state updated to the master and have its facts updated in its cached repository.

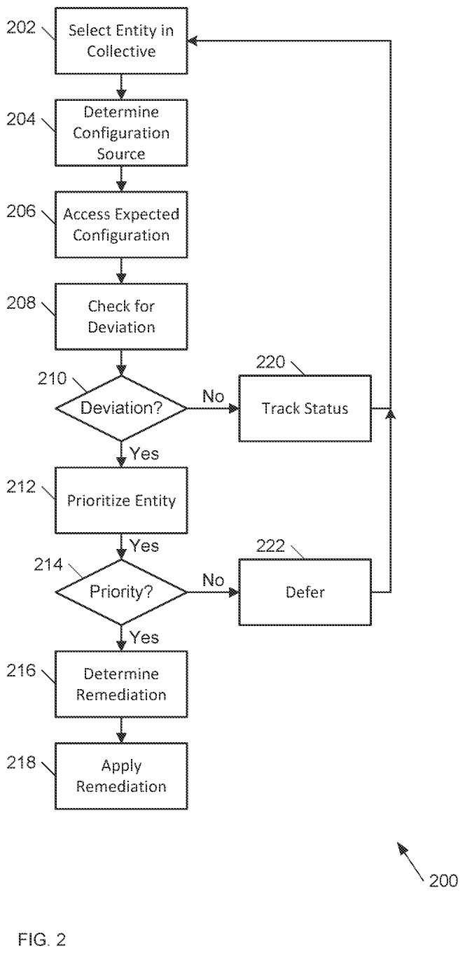

FIG. 2 illustrates, according to one implementation, a high-level system diagram of a database environment 200 in which various aspects of the disclosed technology may be used. In this exemplary implementation, a configuration validation application (which may be implemented as an API or is providing an API) may process a collective (or fleet) of entities, e.g., databases, database systems, and/or machines hosting one or more database.

As discussed above, vendor-controlled management is very intensive, resulting in significant resource and transaction burdens related to implementing deviation identification and remediation. This is particularly true for cloud-hosted databases as each managed host/machine must repeatedly run the puppet agent, and hence many cloud accesses are required to perform management and remediation. In various exemplary implementations illustrated herein, rather than rely on such vendor tools to determine collective entities have a configuration issue (configuration deviation, security vulnerabilities, etc.), and rely on vendor remediation, instead deviation identification and remediation is performed locally. As a local event, remediation may be prioritized according to local interest as opposed to vendor interest. Such local action may reduce burdens related to cloud access for a collective. In one exemplary implementation, rather than each entity in a collective running an agent or other software or operating system component to track configuration compliance, instead a tool in a local environment may inspect entities in a collective for compliance or deviation. In various implementations, “local” refers to, e.g., the client-side of a client (database owner)—server (vendor) configuration.

As illustrated, an entity in the collective is selected 202, and a configuration source is determined 204. It will be appreciated the configuration source may be a Source Code Manager, Source Code Control System, Version Management Control, or other such machine and/or service containing a correct/current expected configuration for the selected entity in the collective. The expected configuration may be accessed 206. It will be appreciated the expected configuration may be determined and/or otherwise obtained by querying the vendor for the expected configuration and/or by having a local copy of the expected configuration stored in a local data storage, e.g., a local database, network storage, etc. In contrast with typical vendor tools, the accesses 206 configuration may be retained and used as a reference for determining deviation of multiple machines in a local environment having the same configuration as the selected 202 entity.

A test may be performed to determine if 210 there is a deviation. If so, then the entity may be prioritized 212. If 214 the affected entity is a priority, e.g., the services it provides are critical, the nature of the deviation is significant, the extent of the deviation is significant, or for other reason it is deemed remediation is time critical, urgent, etc. then the remediation for the entity may be determined 216. As will be appreciated the nature of the remediation is dependent on how configurations are tracked. For example, in a puppet environment, the entity's configuration may be compared to the catalog documenting the desired (correct) state of software and/or hardware of the entity, and it may specify ordered dependency information relating to a desired state. This information may be used to determine 214 the remediation needed to bring the entity back into compliance. With necessary remediation determined, it may then be applied 216 to the entity.

While as noted above a deviated entity may be locally remediated, in an alternate exemplary implementation, the affected entity may be identified to the vendor for its performing remediation. However, since the decision to call out need for remediation has been determined locally, it will be appreciated remediation may be prioritized such that the vendor only remediates higher-priority deviating entities ahead of databases/hosts/database systems, etc. having a lower priority. Even with calling on the vendor to perform remediation, this exemplary implementation facilitates optimizing network transactions in, for example, a public cloud, by avoiding traditional puppet master/puppet agent transaction(s), allowing a locally determined need-based dynamic for entity configuration updating and/or remediation. In particular, local analysis removes need for a puppet agent to be started on each individual entity, and a local configuration engine may apply changes (or request vendor performance) based on locally-determined priority.

If 210 no deviation for the entity was determined, then the status of the entity may be tracked 220, e.g., recorded as being ok, and/or perform other operations (not illustrated). For the purposes of this illustrative discussion, processing may then loop back to selecting 202 another entity in the collective. It will be appreciated while the illustrated implementation may suggest a serial approach to reviewing the entities in a collective, selection 202 and handling of an entity's configuration may be performed in parallel, in groups (e.g., entities may be classified according to their roles, tasks, equipment, pre-established priority, age, load, etc.), or according to any other scheme for choosing one or more entity to evaluate for deviation.

If 214 a deviation was found but the entity is not currently deemed a remediation priority, then remediation may be deferred 222. Deferral may include performing operations (not illustrated) to identify the entity as needing deferred remediation and it may be selected 202 at a later time where at this later time its priority may be such that it will receive remediation at that later time. For the purposes of this illustrative discussion, processing may then loop back to selecting 202 another entity in the collective. It will be appreciated while the foregoing has assumed use of a puppet environment, an API providing local services for the exemplary illustrated operations 202-222 are vendor/tool agnostic. An API may provide a front-end for any back-end management tools, environment, or vendor constraints regardless of the vendor's tools in use.

By localizing deviation detection and remediation, a significant burden reduction may be realized. For example, in a traditional client-server communication model using puppet to manage cloud-based entities in a collective, a puppet agent has to be running on each entity (e.g., each database system), typically on a repeating basis by way of a cron job or scheduler/task trigger. Each time the puppet agent wakes up, it makes a network call to a puppet master which may trigger a series of network operations/data transfers to and from the cloud. If the collective has 10,000 systems, that requires at least 10,000 network calls, in addition to the network calls/data traffic associated with getting the manifests updated correctly on entities with deviations, and the remediation burden. If the network transactions are metered, the burden may include a significant cost. Local prioritization of remediation removes this network traffic and minimizes metered traffic based on local priority and needs.

FIG. 3 illustrates a system diagram 300 according to an exemplary implementation illustrating a corporate data center 302 with a collective hosted by a vendor/cloud provider 304. It will be appreciated various combinations of gateways, routers, VPN and or other communication apparatus 306, 308 may be used to securely connect the data center with the vendor/cloud provider. In particular it will be appreciated there may be multiple gateways, routers, VPNs, etc. to securely connect a data center to a vendor, as well as to physically and/or logically partition (as desired) hosted databases, database collectives, machines, etc. into multiple private networks/subnets 312, 314. It will be appreciated there may be many private networks/subnets. Further, while illustrated are use of cloud-based databases and cloud services 310, such as provided by Amazon, this is for exemplary purposes. Some or all databases, e.g., items 316, 318 and/or private networks/subnets 312, 314 need not be hosted in the cloud or made available through a cloud service. Further, use of Amazon as a vendor is also purely for exemplary purposes as Amazon is a well-known cloud service. The embodiments disclosed herein are cloud/vendor agnostic and may be implemented for and/or within any public or private database/hosting environment.

As illustrated, each private network/subnet 312, 314, has several exemplary components 316-334. It will be appreciated there may be fewer or more components, and in particular illustrated items may represent a high level abstraction of multiple underlying hardware and/or software features or functionality to be accessed to perform operations as described herein. As illustrated there may be a DB on Instance 320, 328 that represents a database running/being hosted by a vendor/cloud provider, which in the illustrated embodiment, refers to a database 316, 318 operating on an Amazon Elastic Compute Cloud (Amazon EC2) instance, which generally speaking is a web service providing scalable cloud-based compute capacity. Note although database 316, 318 are illustrated as a single database they may represent a collective of databases within the private network/subnet 312, 314.

The DB on Instance 320, 328 operates in conjunction with a Configuration Engine, which is a vendor/cloud agnostic application. In the illustrated exemplary implementation, the configuration engine may be implemented as a JAVA REST API working in combination with the processing node (discussed below) and collectors deployed outside of the database systems in a public subnet and that interact with database systems provisioned in multi cloud platforms. The configuration engine watches for the changes and configuration deviations observed within an entity within a collective, e.g., a database, database environment, machine/host, etc., using established and/or known standard configurations defined to evaluate the possible deviations within it or its environment, such as the public cloud environment. The configuration engine operates, as discussed above, to localize determining deviation before engaging the vendor/cloud tools and/or services 310 and therefore avoid or otherwise minimize burdens associated with, for example, cloud-based databases. The API may, as discussed with respect to FIG. 2 item 212, prioritize a deviation and optimize remediation based on the priority. For example, were database 316 and database 318 both misconfigured, but the deviation with database 318 was rated a higher priority, e.g., a security vulnerability taking precedence over a logging issue. In such a case, remediation would be applied to database 318 first, and remediating database 316 deferred to a later time, a different day, or skipped entirely if, for example it was known an upcoming change, update or other event was coming that would render moot the deviation issue with database 316.

While FIG. 3 only shows two private networks/subnets 312, 314, one skilled in the art will appreciate there may be thousands of networks/subnets associated with a corporate data center 302. The configuration engine and its API (or the configuration engine API if it is implemented as an API) therefore play a core role in optimizing transactions with the vendor/cloud provider 304. For example, if there are 10,000 databases associated with the data center, limiting remediation to only those (possibly few) databases with a higher priority deviation may significantly reduce associated remediation burdens. In various embodiments, data related to the nature of a deviation is pushed to the cloud vendor logging system, in the Amazon context, the information is pushed to a S3 log using, e.g., the Amazon S3 API; the log may be stored in a S3 bucket 336, 342 associated with the private network/subnet 312, 314, or it may be maintained separately by the vendor/cloud provider.

AWS λ (AWS Lambda) 338, 344 may be configured to listen for events identified in the log, which may then trigger taking an action. As discussed above, the configuration engine 322, 330 may prioritize deviating entities, e.g., a misconfigured database, a database with a security problem, etc., and based on a local determination of priority, log (directly or by the processing node 326, 334) the issue as desired to trigger a desired action, such as a remediation. AWS Lambda may listen to and respond to events based on the rules and logic defined for each event triggers on AWS S3 and AWS SQS 340, 346. AWS Lambda may look for events from the logger and the message queue (discussed below) based on the priority and interact with a processing node 326, 334 accordingly. In one implementation, when AWS Lambda responds to a log entry and identifies a log entry needing action, this triggers a message to the processing node 326, 334 to analyze the logged issue and determine the action to be performed, e.g. remediation of other action.

The processing node, as illustrated, is local to a private network/subnet 312, 314, and hence it's processing occurs off-vendor/off-cloud, which may alleviate processing burdens associated with the vendor. In one implementation, analysis and remediation determination is a local task based at least in part on the local prioritization recorded in the log. The processing node 326, 334, in various exemplary implementations, may be an application that inherits or otherwise obtains data from the configuration engine 322, 330. In one exemplary implementation an API provides the functionality of both the configuration engine and the processing node. The configuration engine may be integrated with or otherwise communicatively coupled to and invoked by AWS Lambda 338, 344. The processing node may receive contact, e.g., a network call/network transaction, from AWS Lambda, and the processing node may acknowledge the AWS Lambda contact and, in response, inspect the log.

For example, in the Amazon AWS S3 environment, a configuration engine 322, 330, which is off-vendor/off-cloud, may use the S3 API to record log entries to a S3 log file that is typically be stored in a target bucket, e.g., S3 bucket 336, 346. The processing node 326, 334, receiving contact from AWS Lambda 338, 344, may responsively inspect the log data, for example, to identify issues identified in the data that need addressing, to identify the priority queue of systems reported in the log by the configuration engine into the S3 log that may indicate machines requiring remediation, or that identify other data/actions that are of interest. As discussed above, the log may contain a priority queue, or task queue, indicating various issues, some of which may need immediate handling, while others may be deferred. Messages in the AWS log consumed by the processing node 326, 334 may be filtered by applying one or more data attributes, such as the locally derived priority for the logged item, to determine a custom network queue of systems identifying high priority entities needing attention, remediation, updating, etc.

It will be appreciated a network queue of systems may be a collection of database systems based on data modeling generated in the context of database system configurations. Each system in the queue may be categorized based on the priority of the systems services, which as discussed above may be determined locally and be based on any attributes of a database, its host, its services, etc. The custom network queue of systems may be pushed, e.g., by using the AWS DataModel, to the AWS Simple Queue Service (SQS) 340, 346. SQS is a message queuing service enabling decoupling and scaling microservices, distributed systems, and serverless applications. SQS enables sending, storing, and receiving messages between software components working with or within the AWS environment. It will be appreciated SQS is an exemplary messaging system; other messaging systems may be used.

As discussed above, deviation identification, and determining which entities require more immediate attention, updating, remediation, etc. may be performed locally, e.g., off vendor/cloud provider 304, to reduce remediation burdens. In the illustrated exemplary implementation, AWS Lambda 338, 344 is integrated with or otherwise communicatively coupled to listen for the network queue of systems from the SQS message queue, and when necessary, invoke a remediation API to be performed by the processing node 326, 334 which, assuming use of the Puppet environment discussed above, triggers the puppet master orchestrator API. In this illustrated implementation, the Configuration Management API 324, 332 actually performs the desired action on an entity, e.g., performs a remediation or other action as needed. Assuming remediating a database, the database would receive, e.g., updated puppet master information, a new manifest to perform, etc. In an alternate embodiment, remediation is triggered and performance may be performed elsewhere, including by the vendor/cloud provider if desired.

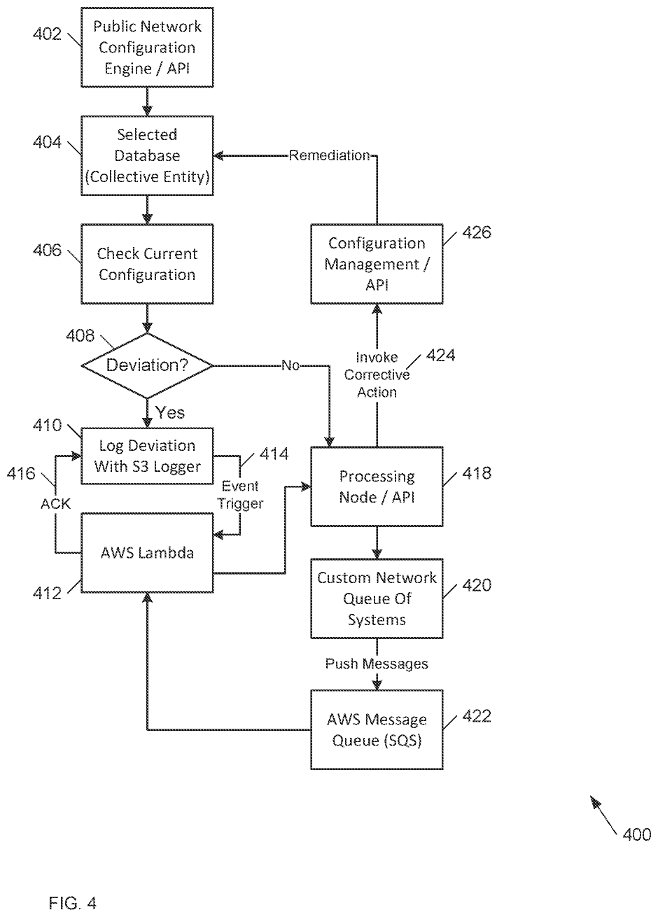

FIG. 4 illustrates a flowchart 400 according to an exemplary implementation. The FIG. 2 exemplary implementation illustrates in part a high-level system diagram of a database environment 200 in which a configuration validation application may monitor a collective of databases and/or machines to ensure correctness of entities in the collective. The FIG. 3 exemplary implementation illustrates a system diagram based at least in part on the FIG. 2 principles operating with an exemplary vendor/cloud provider 304 environment. This FIG. 4 flowchart is based at least in part on the context of the FIG. 3 system diagram.

As illustrated a Public Network Configuration Engine 402, which may be as an API and/or implemented to cooperatively execute with an API, such as a JAVA REST API, operates in conjunction with a processing node (e.g., item 414 discussed below) processing node (discussed below) and collectors, e.g., FIG. 3 items 336, 338, 340 and/or other vendor or cloud features and/or functionality not illustrated, that are deployed outside of the database systems, e.g., FIG. 3 items 316, 318, and in a public subnet (which may be accessible in part by way of the Internet) and that interact with database systems provisioned in multi cloud platforms, e.g., deployed on FIG. 3 private network/subnet 312, 314. Assume a database in a collective has been selected 404 for review. The term selected is intended in the general sense of a particular database is being currently scrutinized. It will appreciated all of the illustrated exemplary embodiments may be parallelized and unless strictly necessary, illustrated operations may be performed in parallel or in a different order as some entities under scrutiny may be associated with different ones of the illustrated exemplary operations. Further while the flowchart suggests transitions from one functionality (e.g., by way of a hardware and/or software component, feature, process, function, call-back, asynchronous call, etc.) to the next, it will be appreciated the parallel nature of the problem renders a strictly linear presentation to be more restricting than the actual implementation of illustrated features and functionality.

Thus while discussion has moved from the public network configuration engine 402, which may be operating as an API, to the selected 404 database, the configuration engine may continue to watch for events of interest such as observed changes and configuration deviations observed within an entity within a collective. To do so, logically, a check 406 must be performed to check the current configuration of the selected database. But again, while this illustration is presented roughly as a sequential flowchart, it will be appreciated the configuration engine may operate in parallel to a check if 408 there is a deviation, and responsive to an indicator, such as data logged 410 with a S3 logger (as discussed above with respect to FIG. 3), the configuration engine may respond to the logged deviation by calling on AWS Lambda (AWS λ) to address the deviation. However, since the configuration engine is a local (e.g., off-cloud functionality, as discussed above) it may locally determine whether the deviation needs to be addressed now, later, or if at all. This may help avoid or otherwise minimize burdens associated with, for example, accessing and modifying cloud-based databases.

AWS Lambda 412, as discussed above with respect to FIG. 3 items 338, 344, may be configured to listen for events logged 410 with a S3 logger. It bears noting while the present illustrated implementation relies heavily on Amazon Web Service, Amazon S3 service, etc., one skilled in the art will appreciate this is for exemplary purposes since the Amazon cloud platform is well-known and well-understood. Other cloud environments, e.g., Microsoft Azure, Google Cloud, Alibaba Cloud, Oracle Cloud, IBM Cloud, etc. may be used as illustrated implementations are exemplary and are cloud agnostic. Since the configuration engine may prioritize responding to deviated entities, e.g., a security vulnerability taking priority over minor misconfigurations, AWS Lambda may listen for and respond to events based on the rules and logic defined for event triggers on AWS S3 or AWS SQS. AWS Lambda may look for an event trigger 414 from the logger, and acknowledge 416 it, which may be performed by logging receipt of that event. The event trigger may then trigger handling by a processing node/API 418. It will be appreciated the configuration engine and processing node may be features and/or functionality of the same API (e.g., one providing the teachings in the exemplary illustrated embodiments), or they may be cooperatively-executing APIs.

The processing node 418 may perform various actions depending on how it is accessed/triggered. For example, if 408 no deviation was found, that status may lead to the processing node to perform actions (not illustrated) such as logging the lack of deviation for the selected 404 database in a collective. If processing comes from the AWS Lambda 412, the processing node 418 may analyze the logged 410 issue to determine the action to be performed. The processing node may filter log entries to determine a custom network queue of systems 420 where the queue identifies entities, e.g., the selected 404 database, needing attention, remediation, updating, etc. The queue may be pushed to the AWS Simple Queue Service (SQS) 422. As a decoupled message queue, it may be used to send messages with, for example, AWS Lambda 412. In the illustrated exemplary implementation, AWS Lambda is integrated with or otherwise communicatively coupled to listen for SQS messages, and if the message(s) indicate remediation is needed, AWS Lambda may return handling to the processing node 418 which may send a message to invoke corrective action 424 to the configuration management/API 426.

Depending on the cloud environment, configuration management 426 will access or otherwise invoke or perform actions necessary to trigger or perform the desired action on an entity, such as to apply remediation operations that have been identified for the selected 410 database. As discussed above, much of the illustrated exemplary implementations may be performed in parallel, and various features or functionality, such as the processing node 418 represents a point in which many different processes and/or procedures may be performed depending on the state of the environment that led to the processing node taking action. That is, if 408 no deviation, or if AWS Lambda 412 is identifying messages from the AWS SQS 422, the processing node will perform different actions accordingly.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices.

Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood they have been presented by way of example only, and not limitation. Thus, the breadth and scope of the present application should not be limited by any of the implementations described herein, but should be defined only in accordance with the following and later-submitted claims and their equivalents.

What is claimed is:

1. A computing system for localizing transactions between a private network and a public cloud hosting a collection of databases, the computing system comprising at least one processor and a memory coupled to the at least one processor and storing instructions that, when executed by the at least one processor, cause the computing system to:
access a data store on the private network storing database configurations;
determine a first configuration in the data store associated with a first database in the collection;
locally check for a first deviation of the first configuration from a first expected configuration;
remotely log with the public cloud a first result of the check for the first deviation;
locally request a first configuration correction from the public cloud for the first deviation;
determine a first corrective action corresponding to the first configuration correction;
determine an operation to apply to a second database in the collection;
prioritize the first corrective action and the operation to determine a priority action; and
locally perform the priority action.

2. The computing system of claim 1, the instructions further including instructions to:
determine a second configuration in the data store associated with the second database in the collection;
locally check for a second deviation of the second configuration from a second expected configuration;
remotely log with the public cloud a second result of the check for the second deviation;
locally request a second configuration correction from the public cloud for the second deviation; and
determine the operation as a second corrective action corresponding to the second configuration correction.

3. The computing system of claim 1, wherein the first corrective action is the first configuration correction.

4. The computing system of claim 1, wherein instructions for localizing transactions includes instructions to cause the computing system to:
perform a heartbeat transaction associated with the first database on the private network.

5. The computing system of claim 1, wherein instructions for localizing transactions includes instructions to cause the computing system to:
perform in a collection of cloud-based databases

6. The computer program of claim 1, wherein the instructions for the locally check for the first deviation further comprising instructions to apply artificial-intelligence based analytics to at least the first configuration to at least identify the first deviation.

7. The computing system of claim 1, wherein instructions for localizing transactions includes instructions to cause the computing system to:
determine the first corrective action is the priority action; and
defer the operation.

8. A database implemented method for localizing transactions between a private network and a public cloud hosting a collection of databases, comprising:
access a data store on the private network storing database configurations;
determine a first configuration in the data store associated with a first database in the collection;
locally check for a first deviation of the first configuration from a first expected configuration;
remotely log with the public cloud a first result of the check for the first deviation;
locally request a first configuration correction from the public cloud for the first deviation;
determine a first corrective action corresponding to the first configuration correction;
determine an operation to apply to a second database in the collection;
prioritize the first corrective action and the operation to determine a priority action; and
locally perform the priority action.

9. The method of claim 8, further comprising:
determine a second configuration in the data store associated with the second database in the collection;
locally check for a second deviation of the second configuration from a second expected configuration;
remotely log with the public cloud a second result of the check for the second deviation;
locally request a second configuration correction from the public cloud for the second deviation; and
determine the operation as a second corrective action corresponding to the second configuration correction.

10. The method of claim 8, wherein the first corrective action is the first configuration correction.

11. The method of claim 8, further comprising:
perform a heartbeat transaction associated with the first database on the private network.

12. The method of claim 8, further comprising:
perform in a collection of cloud-based databases

13. The method of claim 8, further comprising:
apply artificial-intelligence based analytics to at least the first configuration to at least identify the first deviation.

14. The method of claim 8, further comprising:
determine the first corrective action is the priority action; and
defer the operation.

15. A computer program for localizing transactions between a private network and a public cloud hosting a collection of databases, the computing program including instructions to:
access a data store on the private network storing database configurations;
determine a first configuration in the data store associated with a first database in the collection;
locally check for a first deviation of the first configuration from a first expected configuration;
remotely log with the public cloud a first result of the check for the first deviation;
locally request a first configuration correction from the public cloud for the first deviation;
determine a first corrective action corresponding to the first configuration correction;
determine an operation to apply to a second database in the collection;
prioritize the first corrective action and the operation to determine a priority action; and
locally perform the priority action.

16. The computing program of claim 15, the instructions further including instructions to:
determine a second configuration in the data store associated with the second database in the collection;
locally check for a second deviation of the second configuration from a second expected configuration;
remotely log with the public cloud a second result of the check for the second deviation;
locally request a second configuration correction from the public cloud for the second deviation; and
determine the operation as a second corrective action corresponding to the second configuration correction.

17. The computing program of claim 15, the instructions further including instructions to:
perform a heartbeat transaction associated with the first database on the private network.

18. The computing program of claim 15, the instructions further including instructions to:
perform in a collection of cloud-based databases

19. The computing program of claim 15, the instructions further including instructions to:
apply artificial-intelligence based analytics to at least the first configuration to at least identify the first deviation.

20. The computing program of claim 15, the instructions further including instructions to:
determine the first corrective action is the priority action; and
defer the operation.
